(19) United States
(12) Patent Application Publication
(10) Pub. No.: US 2012/0106429 A1
(43) Pub. Date: May 3, 2012

(54) METHOD FOR INTERCONNECTING MOBILE COMMUNICATION TERMINALS IN AD-HOC NETWORK

(75) Inventors: Mingsong HONG, Beijing (CN); Hui Li, Chaoyang (CN)

(73) Assignee: Beijing Borqs Software Technology Co., LTD., Chaoyang (CN)

(21) Appl. No.: 13/292,934

(22) Filed: Nov. 9, 2011

Related U.S. Application Data
(63) Continuation of application No. PCT/CN2010/077558, filed on Oct. 1, 2010.

(30) Foreign Application Priority Data
Feb. 10, 2010 (CN) 2010-10110834.9

(51) Int. Cl. H04W 84/02; H04W 4/06

(52) U.S. Cl. 370/312; 370/338

(57) ABSTRACT

A method for interconnecting mobile communication terminals in an AD-HOC network, comprising generating, by each mobile communication terminal, a broadcast or multicast message comprising a source IP address in the AD-HOC network and a unique identifier corresponding to a mobile communication terminal, and broadcasting or multicasting the message in the AD-HOC network, receiving, by a first mobile communication terminal, the above messages and extracting and saving source IP addresses and unique identifiers contained in the broadcast or multicast messages, generating, by the first mobile communication terminal, an information correspondence list comprising extracted and saved source IP addresses and unique identifiers, and selecting, by a first mobile communication terminal user, a unique identifier from the information corresponding list, and interconnecting with the corresponding mobile communication terminal.

### CROSS-REFERENCE TO RELATED APPLICATIONS

This application is a continuation of International Patent Application No. PCT/CN2010/077558, filed on Oct. 1, 2010, which claims foreign priority from CN 201010110834.9, filed on Feb. 10, 2010, the disclosures of each of which are incorporated herein by reference in their entirety.

### BACKGROUND

1. Field

The present disclosure relates to a method for interconnecting mobile communication terminals, and in certain embodiments relates to a method for interconnecting mobile communication terminals in an AD-HOC network.

2. Description of the Related Art

As mobile communication terminals with wireless local area network (WLAN) AD-HOC functionality are popularized, utilizing an AD-HOC network of mobile communication terminals and implementing direct interconnection between mobile communication terminals in the AD-HOC network has become a common communication technique.

FIG. 6 is a schematic diagram of an AD-HOC network of mobile communication terminals. As shown in FIG. 6, each mobile communication terminal can be interconnected with other mobile communication terminals via the wireless network.

FIG. 7 is a hierarchical diagram of an AD-HOC network protocol stack. As shown in FIG. 7, for a Transmission Control Protocol/Internet Protocol (TCP/IP) network protocol, the AD-HOC module provides Layer 1 (physical layer) and Layer 2 (link layer) capabilities. For other layers above Layer 2, e.g., Layer 3 and Layer 4, the standard TCP/IP protocol stack can be used. A different protocol stack also can be used, even a self-defined protocol stack. However, for mobile communication terminals, at present, it is a common practice to utilize the TCP/IP protocol stack to ensure its universality and compatibility.

### SUMMARY

As long as the TCP/IP protocol stack is used in currently available systems, IP addresses are required. IP addresses can be assigned dynamically with the Dynamic Host Configuration Protocol (DHCP) or configured manually as static addresses. However, for an AD-HOC network, both methods have some drawbacks.

If the DHCP protocol is used, it is apparent that a certain member may not always exist and therefore the DHCP server may not always exist in the network since the AD-HOC network can be a self-organized network.

If a manual static configuration is used, on one hand, the complexity of user configuration may be increased and the requirement for the user's technical background may be higher; on the other hand, the phenomenon that two users configure their devices with the same IP address can occur.

At present, there are some Request for Comments (RFCs) available to solve the problems related with configuration of AD-HOC networks. For example, RFC3927 can implement automatic configuration of relevant IP parameters of an AD-HOC network with a zero-configuration solution. According to the definition of RFC3927, the assigned IP addresses belong to a Class B segment, like 169.254.xxx.xxx (169.254.xxx.xxx/16). Though the user's mobile can be assigned with an IP address, in currently available systems, the user has to input the IP address of the other party when he/she wants to communicate with another member in the AD-HOC network. This approach not only brings inconvenience to the user, but also is error-prone. Even if the first half of an IP address can be set to 169.254 by a setting on the interface of the user's mobile, the second half of the IP address is generated randomly in current systems, bringing in inconvenience to user input.

To solve or at least reduce the effects of some of the above-mentioned drawbacks, some embodiments of the present disclosure provide a method for interconnecting mobile communication terminals in an AD-HOC network.

In an embodiment, a method for interconnecting mobile communication terminals in an AD-HOC network comprises:
1) Generating, by each mobile communication terminal, a broadcast or a multicast message comprising a source IP address in the AD-HOC network and a unique identifier corresponding to a mobile communication terminal, and broadcasting or multicasting the message in the AD-HOC network;
2) Receiving, by a first mobile communication terminal, broadcast or multicast messages in the AD-HOC network, and extracting and saving source IP addresses and unique identifiers contained in the broadcast or multicast messages;
3) Generating, by the first mobile communication terminal, an information corresponding list comprising all extracted and saved source IP addresses and unique identifiers; and
4) Selecting, by a first mobile communication terminal user, a unique identifier from the information corresponding list, and interconnecting with the corresponding mobile communication terminal.

Furthermore, the unique identifier can be a Subscriber Identity Module (SIM) card number or a user-defined unique name.

Certain aspects of the present disclosure can have various advantages and positive effects. In an embodiment, for example, the SIM card information of the mobile communication terminal user or a name in the address book can be used as the unique identifier for communication in an AD-HOC network and can replace the IP address so that the user does not need to input the IP address of the other party when he/she wants to communicate with another mobile communication terminal in the AD-HOC network. In this way, the above-mentioned troubles and errors in user input can be reduced and the interconnection between mobile communication terminals can become more convenient and quicker.

### BRIEF DESCRIPTION OF THE DRAWINGS

The accompanying drawings are provided to help further understanding of the present disclosure, and constitute a part of the specification. These drawings are used to describe certain embodiments of the present disclosure, but do not constitute any limitation to the present disclosure. In the drawings:

FIG. 1 is a flow chart depicting an embodiment of a method for interconnecting mobile communication terminals in an AD-HOC network.

FIG. 2 is a structural diagram of an embodiment of a broadcast or a multicast message that can be used in a method for interconnecting mobile communication terminals in an AD-HOC network.

FIG. 3 is a schematic diagram of an embodiment of an information corresponding list of Subscriber Identity Module card numbers and IP addresses that can be used in a method for interconnecting mobile communication terminals in an AD-HOC network.

FIG. 4 is a schematic diagram of an embodiment of an information corresponding list of names in an address book and Subscriber Identity Module card numbers that can be used in a method for interconnecting mobile communication terminals in an AD-HOC network.

FIG. 5 is a schematic diagram of an embodiment of an information corresponding list of Subscriber Identity Module card numbers, names in an address book, and IP addresses that can be used in a method for interconnecting mobile communication terminals in an AD-HOC network.

FIG. 6 is a schematic diagram of an AD-HOC network.

FIG. 7 is a hierarchical diagram of an AD-HOC network protocol stack.

### DETAILED DESCRIPTION

Hereunder, various embodiments will be described with reference to the accompanying drawings.

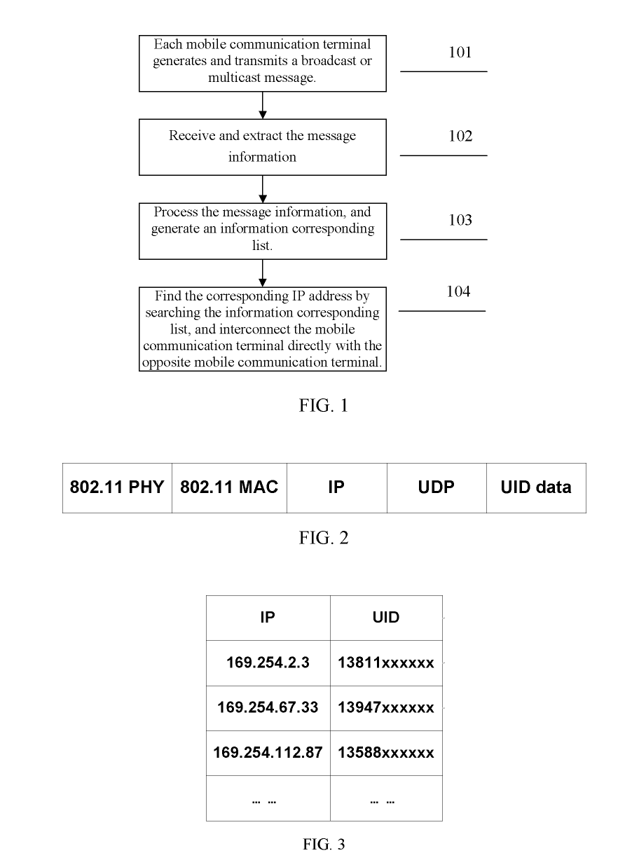

FIG. 1 is a flow chart of an embodiment of a method for interconnecting mobile communication terminals in an AD-HOC network. A method for interconnecting mobile communication terminals in an AD-HOC network will be detailed with reference to FIG. 1.

In block 101, each mobile communication terminal in an AD-HOC network can generate a broadcast or multicast message that contains its IP address and unique identifier in the AD-HOC network, and can transmit the broadcast or multicast message to other mobile communication terminals in the same AD-HOC network.

FIG. 2 is a structural diagram of an embodiment of a broadcast or a multicast message that can be used in a method for interconnecting mobile communication terminals in an AD-HOC network. As shown in FIG. 2, the broadcast or multicast message can be in one or more of the following formats, among others: 802.11 PHY, 802.11 MAC, IP, User Datagram Protocol (UDP), and Unique Identifier (UID). 802.11 PHY and 802.11 MAC represent 802.11 physical layer protocol and media access control layer protocol, respectively. IP indicates the IP address of the mobile communication terminal in the AD-HOC network, and UDP is the user datagram protocol on a network transport layer. UID is the unique identifier that identifies the user's identity, and it can be a Subscriber Identity Module card number or an intuitive user-defined unique name.

In block 102, each mobile communication terminal in the same AD-HOC network can receive broadcast or multicast messages transmitted from other mobile communication terminals. Each mobile communication terminal can extract and save the IP addresses and unique identifiers contained in the broadcast or multicast messages.

In block 103, each mobile communication terminal in the same AD-HOC network can generate an information corresponding list that includes the IP addresses and unique identifiers in the saved broadcast or multicast messages. In an embodiment, the Subscriber Identity Module card number can be used as the unique identifier to describe the composition of the information corresponding list.

FIG. 3 is a schematic diagram of an embodiment of an information corresponding list that includes Subscriber Identity Module card numbers and IP addresses and that can be used in a method for interconnecting mobile communication terminals in an AD-HOC network. As shown in FIG. 3, each mobile communication terminal in the AD-HOC network can utilize the Subscriber Identity Module card numbers and IP addresses contained in the saved broadcast or multicast messages to generate an information corresponding list of Subscriber Identity Module card numbers and IP addresses. In an embodiment, the UID in the information corresponding list can be the Subscriber Identity Module card number and the corresponding IP address can be the IP address of the mobile communication terminal that corresponds to the Subscriber Identity Module card number in the AD-HOC network. Thus, in certain embodiments, each Subscriber Identity Module card number can correspond to an IP address.

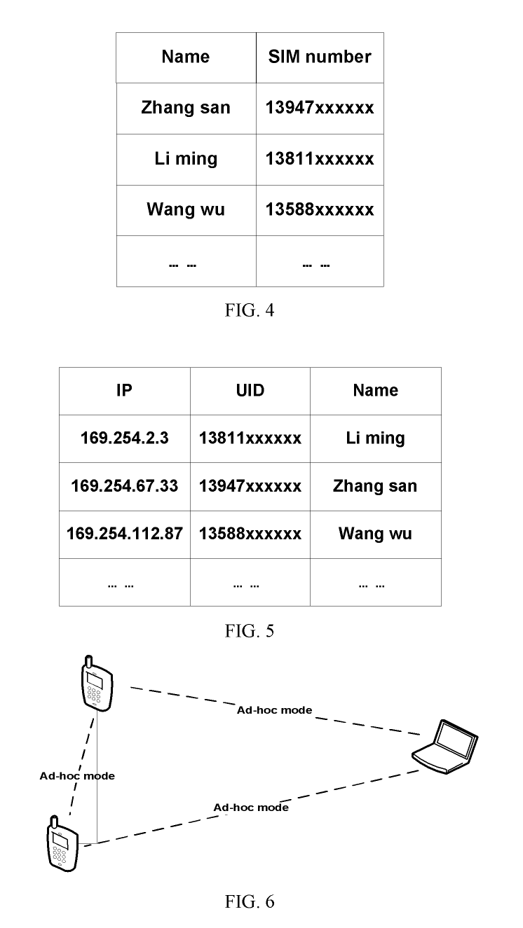

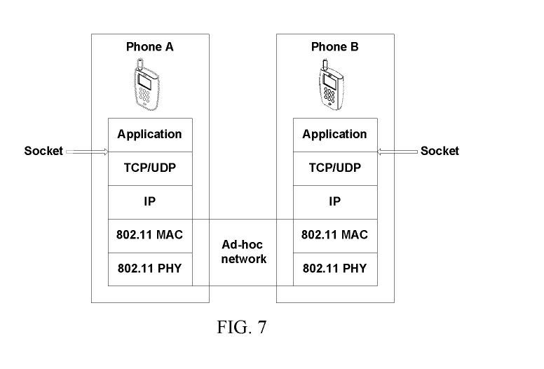

FIG. 4 is a schematic diagram of an embodiment of an information correspondence list of names in an address list and Subscriber Identity Module card numbers that can be used in a method for interconnecting mobile communication terminals in an AD-HOC network. As shown in FIG. 4, each mobile communication terminal in the AD-HOC network can utilize the Subscriber Identity Module card numbers in the saved broadcast or multicast messages and the address book function of the mobile communication terminal to generate an information corresponding list of names in an address book and Subscriber Identity Module card numbers. The names in the address book can be in one-to-one correspondence to the Subscriber Identity Module card numbers.

FIG. 5 is a schematic diagram of an embodiment of an information corresponding list of Subscriber Identity Module card numbers, names in an address book, and IP addresses that can be used in a method for interconnecting mobile communication terminals in an AD-HOC network. As shown in FIG. 5, each mobile communication terminal in the AD-HOC network can utilize the Subscriber Identity Module card numbers and corresponding IP addresses in the saved broadcast or multicast messages and the names corresponding to the Subscriber Identity Module card numbers in the address book in the mobile communication terminal to generate an information corresponding list of names in the address book, Subscriber Identity Module card numbers, and IP addresses. The three elements of the list can be in one-to-one correspondence to each other. The list may contain fewer than all three elements shown in some embodiments.

In an embodiment, some or all mobile communication terminal users in an AD-HOC network can transmit a broadcast or multicast message periodically in order to transmit its IP address and unique identifier to new mobile communication terminals in the network or to inform existing members in the network of its “existence in the AD-HOC network.” In addition, each mobile communication terminal user in the AD-HOC network can receive broadcast or multicast messages transmitted from other mobile communication terminals in the network at any time, maintain its local information corresponding list, and add the Subscriber Identity Module card number, name in an address book, and IP address information of any new mobile communication terminal in the AD-HOC network into the information corresponding list. In that way, the information corresponding list in some or all mobile communication terminals can be updated dynamically, and some or all mobile communication terminal users in the AD-HOC network can be informed of any new mobile communication terminal in the information corresponding list at any time.

In block 104, some or all mobile communication terminal users in the AD-HOC network can select the unique identifier (user name or Subscriber Identity Module card number) of a mobile communication terminal in the information corresponding list when he/she wants to communicate with a certain mobile communication terminal in the AD-HOC network. The mobile communication terminal can transform the unique identifier (user name or Subscriber Identity Module card number) into the corresponding IP address, according to the information corresponding list, and can communicate with the mobile communication terminal corresponding to the IP address. In that way, the mobile communication terminals in the AD-HOC network can be interconnected with each other by means of the Subscriber Identity Module card number and the name in the address book.

In an embodiment, in response to a situation in which there is no user name corresponding to the Subscriber Identity Module card number in the address book in the mobile communication terminal, the Subscriber Identity Module card number can be used to identify the mobile communication terminal directly. In another embodiment, in response to a situation in which the mobile communication terminal is not identified with the Subscriber Identity Module card number, the user can define a name as his/her unique identifier.

Many other variations than those described herein will be apparent from this disclosure. For example, depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A method for interconnecting mobile communication terminals in an AD-HOC network, the method comprising:
generating, by a first mobile communication terminal comprising electronic hardware, a first message comprising a first source IP address in the AD-HOC network and a first unique identifier corresponding to the first mobile communication terminal;
transmitting the first message from the first mobile communication terminal over the AD-HOC network, thereby enabling other mobile communication terminals to identify the first mobile communication terminal by the first unique identifier;
receiving, at the first mobile communication terminal, a second message from a second mobile communication terminal in the AD-HOC network;
extracting a second source IP address and a second unique identifier contained in the second message, the second unique identifier being configured to uniquely identify the second mobile communication terminal;
generating, at the first mobile communication terminal, an information corresponding list that associates the second source IP address and the second unique identifier; and
establishing, by the first mobile communication terminal, a connection with the second mobile communication terminal in response to a selection of the second unique identifier from the information corresponding list by a user of the first mobile communication terminal.

2. The method for interconnecting mobile communication terminals in an AD-HOC network according to claim 1, wherein, the second unique identifier comprises one or more of the following: a Subscriber Identity Module card number or a user-defined unique name.

3. The method for interconnecting mobile communication terminals in an AD-HOC network according to claim 1, wherein the information corresponding list includes Subscriber Identity Module card numbers and source IP addresses.

4. The method for interconnection mobile communication terminals in an AD-HOC network according to claim 1, wherein the information corresponding list includes names in an address book, Subscriber Identity Module card numbers, and source IP addresses.

5. The method for interconnecting mobile communication terminals in an AD-HOC network according to claim 4, further comprising:
identifying, by the first mobile communication terminal, a selection by the first mobile communication terminal user of a name in the address book or a Subscriber Identity Module card number in the information corresponding list;
transforming, at the first mobile communication terminal, the name in the address book or the Subscriber Identity Module card number into the second source IP address; and
establishing, by the first mobile communication terminal, a connection with the second mobile communication terminal associated with the second source IP address.

6. The method for interconnecting mobile communication terminals in an AD-HOC network according to claim 1, wherein the information corresponding list is updated dynamically by the first mobile communication terminal.

7. The method for interconnecting mobile communication terminals in an AD-HOC network according to claim 1, wherein said transmitting the message from the first mobile communication terminal comprises broadcasting the message from the first mobile communication terminal.

8. The method for interconnecting mobile communication terminals in an AD-HOC network according to claim 1, wherein said transmitting the message from the first mobile communication terminal comprises multicasting the message from the first mobile communication terminal.
